(19) United States
(12) Patent Application Publication
(10) Pub. No.: US 2026/0128649 A1
(43) Pub. Date: May 7, 2026

(54) MOTOR ASSEMBLY HAVING END FRAME COOLING SYSTEM

(71) Applicant: Regal Beloit America, Inc., Milwaukee, WI (US)

(72) Inventors: Jeffrey William Crosson, Hermosa Beach, CA (US); Rafal Pawel Rohoza, Melbourne (AU); Jibu John, Melbourne (AU); Joshua Daniel Bragagnolo, Melbourne (AU); Greg Heins, Melbourne (AU)

(21) Appl. No.: 18/940,462

(22) Filed: Nov. 7, 2024

(51) Int. Cl. H02K 9/06; H02K 9/08; H02K 9/22

(52) U.S. Cl. CPC H02K 9/06; H02K 9/08; H02K 9/227

(57) ABSTRACT

A motor assembly is provided that includes a housing, and a mounting bracket coupled to an end of the housing. The mounting bracket and the housing defining a first compartment. The motor assembly also includes a motor positioned within the first compartment, and a heatsink casing coupled to the housing, opposite the mounting bracket. The heatsink casing includes a plurality of heatsink protrusions disposed within the heatsink casing. Additionally, the motor assembly includes a shroud positioned adjacent the heatsink casing, opposite the mounting bracket, where the shroud defines a second compartment. The motor assembly also includes a shaft coupled to the motor, extending axially through the heatsink casing and the second compartment. Furthermore, the motor assembly also includes a fan coupled to the shaft and is positioned within the second compartment, between the shroud and the plurality of heatsink protrusions disposed within the heatsink casing.

### BACKGROUND

The field of the disclosure relates generally to a motor assembly and, more particularly, to a motor assembly having an end frame cooling system.

At least some known electric motor assemblies include various components that generate heat during operation and include fans for cooling those components. However, directing airflow to a desired location relative to the electric motor assembly, with sufficient volume, can be challenging. Typical electric motor assemblies use components to assist in directing the airflow to the desired location. However, additional components require the assembly to be larger and have a higher cost. Therefore, a need exists for a simplified electric motor assembly to accomplish directing airflow to the desired location.

This background section is intended to introduce the reader to various aspects of art that may be related to various aspects of the present disclosure, which are described and/or claimed below. This discussion is believed to be helpful in providing the reader with supporting information to facilitate a better understanding of the various aspects of the present disclosure. Accordingly, it should be understood that these statements are to be read in this light, and not as admissions of prior art.

### BRIEF DESCRIPTION

In one aspect, a motor assembly is provided that includes a housing, and a mounting bracket coupled to an end of the housing. The mounting bracket and the housing defining a first compartment. The motor assembly also includes a motor positioned within the first compartment, and a heatsink casing coupled to the housing, opposite the mounting bracket. The heatsink casing includes a plurality of heatsink protrusions disposed within the heatsink casing and configured to receive airflow surrounding the housing. Additionally, the motor assembly includes a shroud positioned adjacent the heatsink casing, opposite the mounting bracket, where the shroud defines a second compartment. The motor assembly also includes a shaft coupled to the motor and is configured to rotate about an axis. The shaft extends axially through the heatsink casing and the second compartment defined by the shroud. Furthermore, the motor assembly also includes a fan coupled to the shaft and is positioned within the second compartment, between the shroud and the plurality of heatsink protrusions disposed within the heatsink casing. The fan is configured to draw airflow from the plurality of heatsink protrusions.

In another aspect, a motor assembly is provided that includes a housing defining a first compartment, a mounting bracket coupled to an end of the housing, and a motor positioned within the first compartment. The motor assembly also includes a heatsink casing coupled to the housing, opposite the mounting bracket. The heatsink casing includes a plurality of heatsink protrusions disposed within the heatsink casing that are configured to receive airflow surrounding the housing. The motor assembly further includes a shroud positioned adjacent the heatsink casing, opposite the mounting bracket, where the shroud defines a second compartment. Furthermore, the motor assembly includes a fan positioned within the second compartment, between the shroud and the plurality of heatsink protrusions disposed within the heatsink casing. The fan is configured to draw airflow from the plurality of heatsink protrusions.

In yet another aspect, a method of operating a motor assembly is provided, where the motor assembly includes a housing defining a first compartment, a mounting bracket coupled to an end of the housing, a motor positioned within the first compartment, and a heatsink casing coupled to the housing, opposite the mounting bracket. The heatsink casing includes a plurality of heatsink protrusions disposed within the heatsink casing. The motor assembly also includes a shroud positioned adjacent the heatsink casing, opposite the mounting bracket, where the shroud defines a second compartment. The motor assembly also includes a shaft coupled to the motor and extends axially through the heatsink casing and the second compartment defined by the shroud, and a fan coupled to the shaft and positioned within the second compartment, between the shroud and the plurality of heatsink protrusions disposed within the heatsink casing. The method of operating includes drawing airflow from outside the motor assembly through the plurality of heatsink protrusions included within the heatsink casing, and flowing the airflow from the plurality of heatsink protrusions to the fan positioned within the second compartment defined by the shroud. The method also includes circulating the airflow within the second compartment of the shroud based on a rotation of the fan, and directing the airflow from the second compartment of the shroud to an exterior of the housing.

As used herein, “a”, “an”, and “the” refer to both singular and plural referents unless the context clearly dictates otherwise.

As used herein, the term “about” refers to a measurable value such as a parameter, an amount, a temporal duration, and the like and is meant to include variations of +/−15% or less, preferably variations of +/−10% or less, more preferably variations of +/−5% or less, even more preferably variations of +/−1% or less, and still more preferably variations of +/−0.1% or less of and from the particularly recited value, in so far as such variations are appropriate to perform in the one or more embodiments of the disclosure described herein. Furthermore, it is also to be understood that the value to which the modifier “about” refers is itself specifically disclosed herein.

As used herein, spatially relative terms, such as “beneath”, “below”, “lower”, “above”, “upper”, “front”, “back”, “side”, “left”, “right”, “rear”, “top”, “bottom”, and the like, are used for ease of description to describe one element or feature's relationship to another element(s) or feature(s). It is further understood that the terms “front”, “back”, “left”, and “right” are not intended to be limiting and are intended to be interchangeable, where appropriate. Further, it should be noted that the terms “first,” “second,” and the like herein do not denote any order, quantity, or relative importance, but rather are used to distinguish one element from another.

As used herein, the terms “comprise(s)”, “comprising”, and the like, specify the presence of stated features, integers, steps, operations, elements, and/or components, but do not preclude the presence or addition of one or more other features, integers, steps, operations, elements, components, and/or groups thereof.

As used herein, the terms “configure(s)”, “configuring”, and the like, refer to the capability of a component and/or assembly, but do not preclude the presence or addition of other capabilities, features, components, elements, operations, and any combinations thereof.

All ranges disclosed herein are inclusive of the endpoints, and the endpoints are independently combinable with each other. Each range disclosed herein constitutes a disclosure of any point or sub-range lying within the disclosed range.

All methods described herein can be performed in any suitable order unless otherwise indicated herein or otherwise clearly contradicted by context. The use of any and all examples, or exemplary language (e.g., “such as”), is intended merely to better illustrate the embodiments of the disclosure and does not pose a limitation on the scope of the disclosure or any embodiments unless otherwise claimed.

Any combination or permutation of features, functions, and/or embodiments as disclosed herein is envisioned. Additional advantageous features, functions, and applications of the disclosed systems, methods, and assemblies of the present disclosure will be apparent from the description which follows, particularly when read in conjunction with the appended figures. All references listed in this disclosure are hereby incorporated by reference in their entireties.

### BRIEF DESCRIPTION OF THE DRAWINGS

Features and aspects of embodiments are described below with reference to the accompanying drawings, in which elements are not necessarily depicted to scale. Corresponding reference characters indicate corresponding parts throughout the several views of the drawings.

Exemplary embodiments of the present disclosure are further described with reference to the appended figures. It is to be noted that the various features, steps and combinations of features/steps described below and illustrated in the figures can be arranged and organized differently to result in embodiments which are still within the scope of the present disclosure.

To assist those of ordinary skill in the art in making and using the disclosed assemblies and systems, reference is made to the appended figures, wherein:

FIG. 1 is a perspective view of an exemplary motor assembly including a cooling system;

FIG. 2 is a cross-sectional view of the motor assembly shown in FIG. 1;

FIG. 3 is a partially exploded, perspective view of the motor assembly shown in FIG. 1;

FIG. 4 is an exploded, perspective view of a heatsink casing and a heatsink cover that may be used with the motor assembly shown in FIG. 1;

FIG. 5 is a partially exploded, perspective view of the cooling system of the motor assembly shown in FIG. 1;

FIG. 6 is a perspective view of a fan and a shroud of the cooling system that may be used with the motor assembly shown in FIG. 1;

FIG. 7 is a bottom view of the motor assembly shown in FIG. 1;

FIG. 8 is a perspective view of another exemplary motor assembly including a cooling system;

FIG. 9 is a partially exploded, perspective view of the motor assembly shown in FIG. 8;

FIG. 10 is a perspective view of a fan and a shroud of the cooling system that may be used with the motor assembly shown in FIG. 8;

FIG. 11 is a bottom view of the motor assembly shown in FIG. 8;

FIG. 12 is a perspective view of an additional exemplary motor assembly including a cooling system;

FIG. 13 is a partially exploded, rear perspective view of the motor assembly shown in FIG. 12;

FIG. 14 is a partially exploded, front perspective view of the motor assembly shown in FIG. 12;

FIG. 15 is a perspective view of another exemplary motor assembly including a cooling system and a fan motor; and

FIG. 16 is a partially exploded, perspective view of the motor assembly shown in FIG. 15.

### DETAILED DESCRIPTION

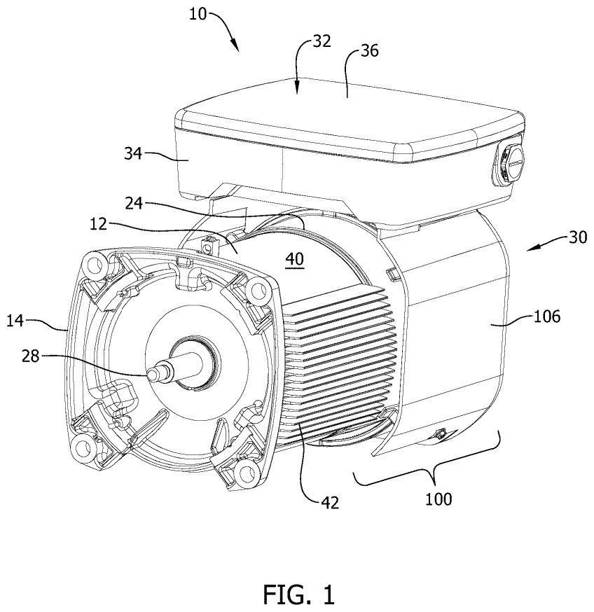

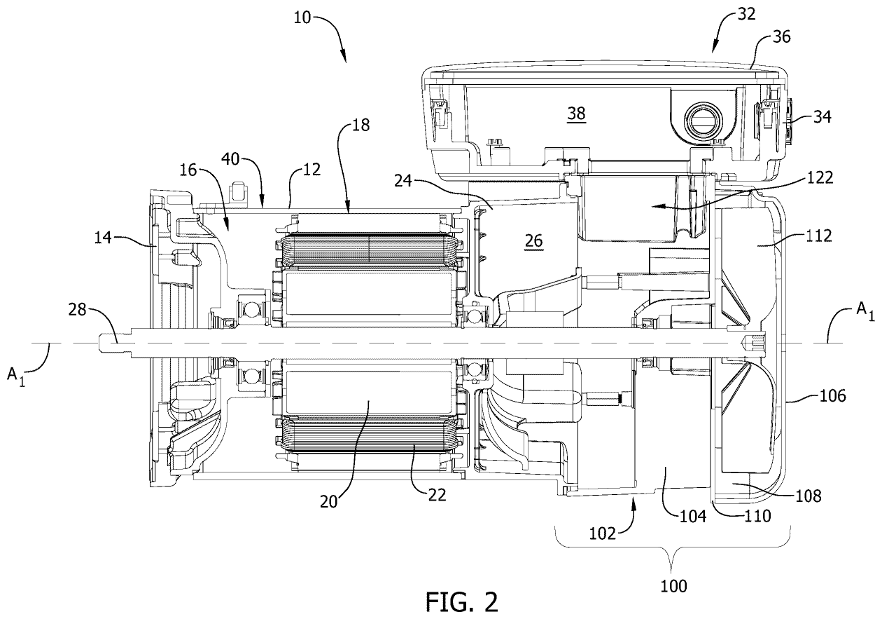

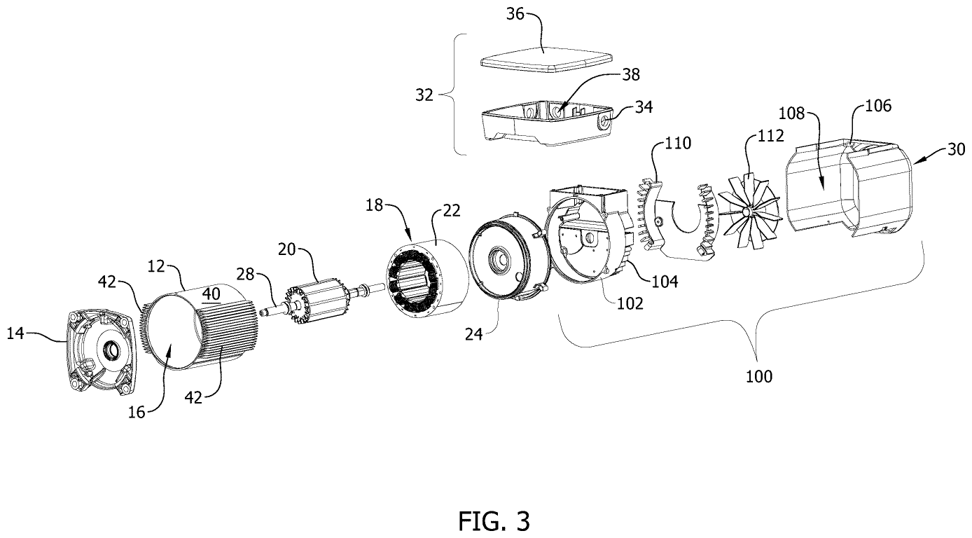

FIG. 1 is a perspective view of an exemplary motor assembly 10 and FIG. 2 is a cross-sectional view of motor assembly 10 depicted in FIG. 1. FIG. 3 is a partial exploded view of motor assembly 10 depicted in FIG. 1. In an exemplary embodiment, motor assembly 10 includes a housing 12 coupled to a mounting bracket 14. Housing 12, mounting bracket 14, and intermediary housing 24 combine to define a cavity. The housing cavity is referred to as a first compartment 16. First compartment 16 is sized and shaped to receive at least a portion of a motor 18. That is, at least a portion of motor 18 of motor assembly 10 is positioned within first compartment 16. Motor 18 includes a rotor 20 and a stator 22 circumscribing rotor 20. In the exemplary embodiment, rotor 20 and stator 22 are positioned within housing 12 and/or first compartment 16 of motor assembly 10.

An intermediary housing 24 is positioned in proximity to motor 18 and is coupled to housing 12. Intermediary housing 24 is attached to at least one of housing 12 and/or a heatsink casing 102, as discussed herein. Intermediary housing 24 may be attached to housing 12 and/or heatsink casing 102, either directly or indirectly, by way of fasteners, mounting features, adhesives, and combinations thereof. However, it should be understood that alternative forms of attachment may be used without departing from the spirit/scope of this disclosure. A cavity 26 is defined by intermediary housing 24 and heatsink casing 102, and cavity 26 may house and/or contain additional components of motor assembly 10 including, but not limited to, electrical control components, electrical interconnects, wires, and the like.

In the exemplary embodiment, at least a portion of a shaft 28 is disposed through intermediary housing 24. More specifically, shaft 28 of motor 18 extends through axially aligned openings provided in mounting bracket 14, rotor 20, stator 22, and intermediary housing 24. Motor assembly 10 defines an axis A₁ that extends the entirety of assembly 10 through the aligned openings in mounting bracket 14, rotor 20, stator 22, and intermediary housing 24. Shaft 28 is aligned with the axis A₁. As discussed herein, shaft 28 of motor 18 also extends through various portions or components of an end frame cooling system 100 (e.g., heatsink casing 102, shroud 106, heatsink cover 110, etc.), as discussed herein.

Motor assembly 10 also includes an end frame cooling system 100. End frame cooling system 100 (hereafter, “cooling system 100”) is formed or positioned at an end 30 of motor assembly 10, opposite mounting bracket 14. In the exemplary embodiment, cooling system 100 includes a heatsink casing 102. Heatsink casing 102 is coupled to motor assembly 10. More specifically, heatsink casing 102 is coupled to intermediary housing 24, such that intermediary housing 24 is disposed or positioned between housing 12 and heatsink casing 102. In one embodiment, heatsink casing 102 is releasably and/or removably coupled to housing 12 and/or intermediary housing 24 of motor assembly 10 using any suitable coupling component and/or technique. For example, heatsink casing 102 can be releasably coupled to housing 12 and/or intermediary housing 24 using bolts-and-nuts. As shown in FIG. 2, and in combination with intermediary housing 24, heatsink casing 102 defines cavity 26 within motor assembly 10. As discussed herein, heatsink casing 102 includes a plurality of heatsink protrusions 104 disposed within heatsink casing 102 that are configured to receive airflow surrounding heatsink casing 102 for cooling motor assembly 10.

Cooling system 100 also includes a shroud 106 positioned adjacent heatsink casing 102. In the exemplary embodiment, shroud 106 is positioned adjacent heatsink casing 102 at end 30 of motor assembly 10, opposite mounting bracket 14. In the exemplary embodiment, shroud 106 is releasably coupled directly to heatsink casing 102 using any suitable coupling component and/or coupling technique. With reference to FIGS. 1-3, and as discussed herein, two opposing sidewalls of shroud 106 may extend adjacent, substantially parallel with, and/or may at least partially surround at least a portion of heatsink casing 102, housing 12, and/or intermediary housing 24 to facilitate the supplying of airflow to housing 12. The various portions (e.g., sidewalls, end wall, etc.) of shroud 106 combine to define a cavity. The shroud cavity is referred to as a second compartment 108. Second compartment 108 is sized and shaped to receive various components of cooling system 100. For example, and as discussed herein, second compartment 108 is sized and/or shaped to receive a fan 112 of cooling system 100.

A heatsink cover 110 is releasably coupled to heatsink casing 102 of motor assembly 10. As shown, heatsink cover 110 is disposed and/or positioned between heatsink casing 102 and shroud 106 of cooling system 100. As discussed herein, heatsink cover 110 includes an inlet to expose the plurality of heatsink protrusions 104 to the airflow surrounding motor assembly 10 to facilitate cooling of heatsink protrusions 104 and housing 12. In one embodiment, second compartment 108 of cooling system 100 is defined by heatsink cover 110, heatsink casing 102, and shroud 106. Additionally as shown, and as discussed herein, each of heatsink casing 102 and heatsink cover 110 can include an opening, recess, and/or aperture for receiving at least a portion of shaft 28. Such that, shaft 28 extends axially through heatsink casing 102, heatsink cover 110, and into second compartment 108 defined, at least partially by, shroud 106.

Cooling system 100 positioned at end 30 of motor assembly 10 also includes a fan 112. Fan 112 is coupled to shaft 28. More specifically, fan 112 is coupled to a portion or end of shaft 28 positioned or extending within second compartment 108. As such, fan 112 is also positioned within second compartment 108 at least partially defined by shroud 106, and is positioned adjacent and/or between shroud 106 and heatsink cover 110. Fan 112 is also positioned between shroud 106 and the plurality of heatsink protrusions 104 disposed within heatsink casing 102. In the exemplary embodiment, heatsink cover 110 is positioned or disposed between and separates the plurality of heatsink protrusions 104 of heatsink casing 102 and fan 112. Fan 112 of cooling system 100 is configured to draw airflow from the plurality of heatsink protrusions 104 and subsequently flow the airflow toward housing 12 of motor assembly 10.

Motor assembly 10 also includes a terminal box 32. Terminal box 32 includes a base 34 coupled to heatsink casing 102, and a lid 36 removably coupled to base 34. Base 34 and lid 36 define an internal compartment 38 that houses a plurality of electrical control components therein. Additionally, and as shown in FIG. 2, internal compartment 38 of terminal box 32 can be in communication with and/or can be accessible through cavity 26 defined by intermediary housing 24 and heatsink casing 102.

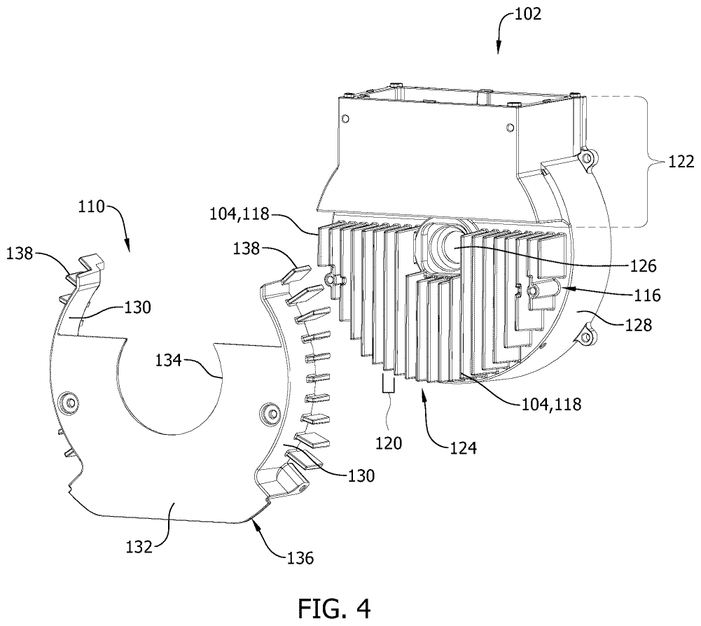

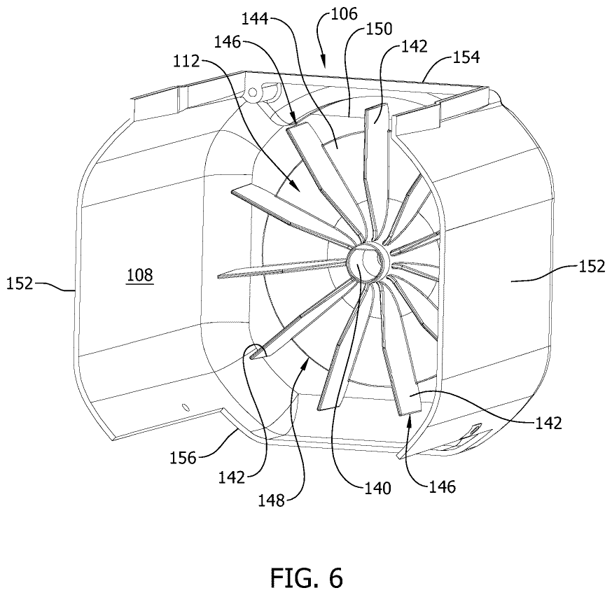

FIG. 4 is a partial exploded view of heatsink casing 102 and heatsink cover 110 of cooling system 100 for motor assembly 10 of FIGS. 1-3, and FIG. 5 is a partially exploded view of cooling system 100 of motor assembly 10 of FIGS. 1-3. Additionally, FIG. 6 is a perspective view of shroud 106 and fan 112 of cooling system 100 for motor assembly 10 of FIGS. 1-3, and FIG. 7 is a bottom view of motor assembly 10 of FIGS. 1-3. It is to be understood that similarly numbered and/or named components may function in a substantially similar fashion. Redundant explanation of these components has been omitted for clarity.

Heatsink casing 102 includes the plurality of heatsink protrusions 104. The plurality of heatsink protrusions 104 extend from a surface 116 of heatsink casing 102. In the non-limiting example, the plurality of heatsink protrusions 104 are formed as a plurality of parallel fins 118 extending substantially perpendicularly from surface 116 of heatsink casing 102. Each of the plurality of parallel fins 118 forming the plurality of heatsink protrusions 104 are separated from adjacent fins 118 by a space 120. Space 120 allows airflow surrounding motor assembly 10 to flow through and/or between each of the plurality of parallel fins 118 forming the plurality of heatsink protrusions 104. In the non-limiting example, the plurality of heatsink protrusions 104 are formed on a lower portion of heatsink casing 102, where heatsink casing 102 provides a passthrough section 122 between internal compartment 38 of terminal box 32 (see, FIG. 2) and cavity 26 defined by intermediary housing 24 and heatsink casing 102. As discussed herein, the plurality of heatsink protrusions 104 are exposed to the airflow surrounding heatsink casing 102 adjacent a bottom portion 124 of heatsink casing 102 during operation to receive airflow (AF).

Heatsink casing 102 also includes an opening 126 formed through heatsink casing 102. More specifically, opening 126 is formed through heatsink casing 102 and is substantially surrounded by the plurality of heatsink protrusions 104. Opening 126 is axially aligned with shaft 28 and is configured to receive a portion of shaft 28 and/or allow shaft 28 to pass therethrough. In the exemplary embodiment, opening 126 of heatsink casing 102 supports shaft 28 of motor 18, and facilitates the rotation of shaft 28 during operation.

Heatsink casing 102 also includes substantially curved sidewalls 128 that in one embodiment correlate, correspond, and/or are substantially similar (e.g., concentric) with the curvature in exterior surface 40 of housing 12. As discussed herein, airflow (AF) is flowed over sidewalls 128 of heatsink casing 102 to flow over, interact with, and/or contact exterior surface 40 and/or the plurality of fins 42 formed on exterior surface 40 of housing 12 during operation of motor assembly 10.

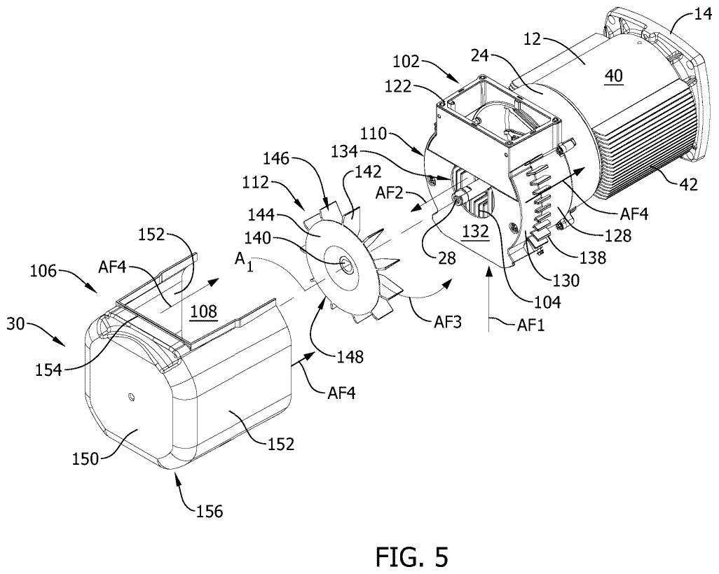

In the exemplary embodiment, heatsink cover 110 includes opposing sidewalls 130 that are positioned directly adjacent heatsink casing 102. More specifically, and with reference to FIG. 5, opposing sidewalls 130 are positioned directly adjacent, and may abut curved sidewalls 128 of heatsink casing 102. Additionally as shown, opposing sidewalls 130 of heatsink cover 110 are substantially curved. The curvature of opposing sidewalls 130 of heatsink cover 110 may correlate, correspond, and/or be substantially similar (e.g., concentric) with the curvature in curved sidewalls 128 of heatsink casing 102.

Heatsink cover 110 also includes a wall portion 132 extending between opposing sidewalls 130. Wall portion 132 is positioned directly adjacent the plurality of heatsink protrusions 104, and/or is positioned between the plurality of heatsink protrusions 104 and fan 112 when heatsink cover 110 is coupled to heatsink casing 102 (see, FIG. 5). In the exemplary embodiment, wall portion 132 of heatsink cover 110 is formed, sized, and/or shaped to be axially aligned with, cover, and/or surround the plurality of heatsink protrusions 104. Additionally, wall portion 132 may also contact and/or abut passthrough section 122 of heatsink casing 102. As discussed herein, wall portion 132 of heatsink cover 110 covers or surrounds the plurality of heatsink protrusions 104 to ensure airflow moves through the plurality of heatsink protrusions 104 and/or the plurality of parallel fins 118 (e.g., between spaces 120) before flowing to fan 112 of cooling system 100.

As shown in FIGS. 4 and 5, cover 110 also includes a recess 134 formed in wall portion 132. In the exemplary embodiment, recess 134 is formed in and/or through wall portion 132 of heatsink cover 110. Recess 134 allows shaft 28 to passthrough heatsink cover 110 and extend into second compartment 108 defined by shroud 106. Additionally, recess 134 formed in wall portion 132 of cover 110 facilitates and/or enables fluid communication between the plurality of heatsink protrusions 104 and fan 112 during operation. Specifically, wall portion 132 ensures airflows moves between the plurality of protrusions 104 and/or within spaces 120 formed between the plurality of parallel fins 118. Additionally, recess 134 enables the airflow previously flowed over the plurality of heatsink protrusions 104 to subsequently flow to fan 112. In the exemplary embodiment, recess 134 is axially aligned with shaft 28 and the center of fan 112 to provide, supply, and/or flow airflow (AF) from the plurality of heatsink protrusions 104 toward the center of fan 112 of cooling system 100.

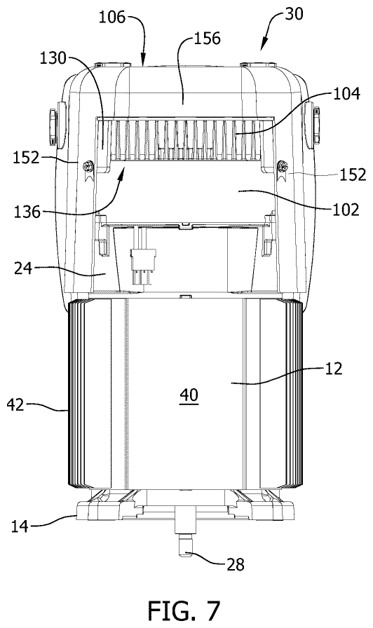

Briefly turning to FIG. 7, and with continued reference to FIGS. 4 and 5, heatsink cover 110 also includes an inlet 136 defined by opposing sidewalls 130 and wall portion 132. In a non-limiting example, inlet 136 is a gap, void, and/or break in heatsink cover 110 that allows air to flow to the plurality of heatsink protrusions 104. Inlet 136 can be formed adjacent bottom portion 124 of heatsink casing 102, to expose at least a portion of the plurality of heatsink protrusions 104.

Returning again to FIGS. 4 and 5, cooling system 100 includes a plurality of guide vanes 138. The plurality of guide vanes 138 aid in directing the airflow from fan 112 toward housing 12. In the exemplary embodiment, the plurality of guide vanes 138 are formed integral with and/or coupled to heatsink cover 110. More specifically, the plurality of guide vanes 138 are disposed circumferentially over at least a portion of the curved, opposing sidewalls 130 of heatsink cover 110. Additionally, the plurality of guide vanes 138 shown may extend axially beyond heatsink cover 110 and may contact and/or be disposed over a portion of sidewalls 128 of heatsink casing 102. During operation, shroud 106 of cooling system 100 may substantially cover and/or contact each of the plurality of guide vanes 138 formed on heatsink cover 110.

Fan 112 of cooling system 100 is positioned between shroud 106 and the plurality of heatsink protrusions 104 disposed within heatsink casing 102. Fan 112 is also rotatably coupled to shaft 28. As shown in FIGS. 5 and 6, fan 112 includes a shaft aperture 140 for receiving shaft 28. Shaft aperture 140 is axially aligned with shaft 28 within motor assembly 10. During operation, as shaft 28 of motor 18 rotates, fan 112 of cooling system 100 also rotates within second compartment 108. As discussed herein, the rotation of fan 112 draws or induces airflow (AF) from the plurality of heatsink protrusions 104 and flows the airflow through shroud 106 and toward housing 12.

Fan 112 also includes a plurality of blades 142 that extend radially from shaft aperture 140. Additionally, the plurality of blades 142 are radially positioned and/or radially extend from the axis (A1) along which shaft 28 of motor 18 rotates within motor assembly 10. The number of blades and/or the airfoil shape of the plurality of blades 142 shown are illustrative. As such, fan 112 can include more or less blades than that shown, and/or can include distinct airfoil shapes or curvatures other than those shown to facilitate airflow (AF) flowing through cooling system 100 to housing 12.

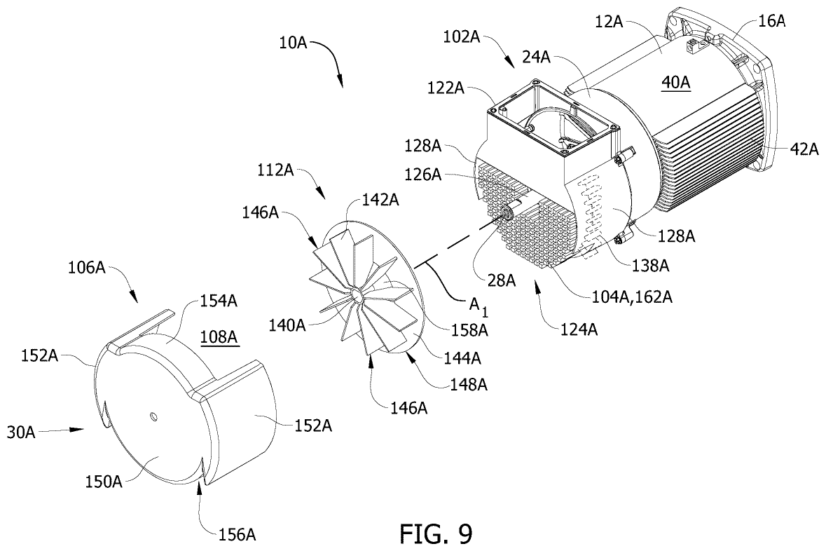

As shown, fan 112 also includes a fan shroud 144. Fan shroud 144 is coupled to each blade of the plurality of blades 142 of fan 112. That is, each of the plurality of blades 142 of fan 112 are coupled and/or affixed to fan shroud 144. Additionally, fan shroud 144 is concentrically aligned with shaft aperture 140 and/or the axis (A1) of motor assembly 10. In the exemplary embodiment, fan shroud 144 is a solid feature that extends from shaft aperture 140 radially and circumferentially outward toward tips 146 of each blade of the plurality of blades 142. In other non-limiting examples, fan shroud 144 can include an opening extending therethrough (see e.g., FIG. 9). As shown, fan 112 is oriented within cooling system 100 such that fan shroud 144 is positioned between the plurality of blades 142 and shroud 106. More specifically, fan blades 142 are positioned directly adjacent heatsink cover 110 such that fan blades 142 are positioned between heatsink cover 110 and fan shroud 144. Additionally, a portion of the plurality of blades 142 extend radially beyond or past an outer perimeter 148 of fan shroud 144. That is, tips 146 of each blade 142 extend radially beyond or past outer perimeter 148 of fan shroud 144.

As shown herein, shroud 106 is positioned opposite bracket 14 and is coupled to heatsink casing 102 to define second compartment 108. Shroud 106 includes an end wall 150 positioned adjacent fan 112. End wall 150 is formed opposite bracket 14 of motor assembly 10, and/or adjacent end 30 of motor assembly 10. Shroud 106 also includes two opposing sidewalls 152 extending from end wall 150 toward housing 12. As shown in FIG. 5, and briefly returning to FIG. 1, sidewalls 152 of shroud 106 are positioned adjacent and/or substantially surround fan 112, heatsink cover 110, heatsink casing 102, and/or intermediary housing 24. In the exemplary embodiment, the plurality of guide vanes 138 are formed on opposing sidewalls 130 of heatsink cover 110, and sidewalls 152 of shroud 106 also extend adjacent and/or substantially surround the plurality of guide vanes 138. As discussed herein, the plurality of guide vanes 138 and sidewalls 152 of shroud 106 facilitate the flowing of airflow (AF) from shroud 106 to housing 12 of motor assembly 10.

Shroud 106 also includes a top wall 154 and a bottom wall 156. Top wall 154 extends toward, contacts, and/or is coupled to heatsink casing 102, above fan 112. In the exemplary embodiment, top wall 154 contacts and/or is coupled directly to passthrough section 122 of heatsink casing 102. Additionally, top wall 154 covers and/or surrounds at least a portion of fan 112. Bottom wall 156 extends from end wall 150 toward heatsink casing 102, and is disposed below fan 112. As shown in FIG. 7, bottom wall 156 of shroud 106 extends toward casing 102, but does not obstruct inlet 136 of heatsink cover 110 and does not cover or obstruct the plurality of heatsink protrusions 104 included within heatsink casing 102. As such, the plurality of heatsink protrusions 104 are exposed adjacent bottom wall 156 of shroud 106 to facilitate airflow through the plurality of heatsink protrusions 104 during operation.

Returning to FIG. 5, airflow (AF) path is shown with respect to reference arrows (AF1-AF4). As discussed herein, airflow surrounds motor assembly 10 and is utilized by cooling system 100 to cool both heatsink casing 102 including the plurality of heatsink protrusions 104, as well as housing 12 including motor 18 therein. Initially, airflow moves through the plurality of heatsink protrusions 104 of cooling system 100 and flows from under motor assembly 10 and/or flows radially (upward) through the exposed plurality of heatsink protrusions 104 from bottom portion 124 of heatsink casing 102. As airflow (AF1) flows through the plurality of heatsink protrusions 104, and more specifically within the spaces 120 formed between each of the plurality of parallel fins 118, heatsink casing 102 and/or the plurality of heatsink protrusions 104 are cooled.

Airflow is then provided to fan 112 of cooling system 100. In the exemplary embodiment, airflow (AF2) flows from the plurality of heatsink protrusions 104, through recess 134 formed in heatsink cover 110, and is directed axially toward the center of fan 112 (e.g., shaft aperture 140) positioned within second compartment 108 defined by shroud 106. As a result of fan 112 rotating with shaft 28, airflow (AF2) may also be induced and/or drawn into fan 112 through recess 134 and/or from the plurality of heatsink protrusions 104. As discussed herein, wall portion 132 of heatsink cover 110 ensures that airflow (AF1) does not prematurely flow to fan 112 and/or the plurality of heatsink protrusions 104 are exposed to airflow (AF1) before airflow (AF2) is provided to fan 112 of cooling system 100.

Airflow (AF3) is circulated within second compartment 108 due to the rotation of fan 112 that moves and/or circulates airflow (AF3) within second compartment 108 defined by shroud 106. Shroud 106 and heatsink cover 110 ensure that airflow (AF3) is not recirculated back into heatsink casing 102 via recess 134 formed in heatsink cover 110. As discussed herein, airflow (AF2) is directed toward the center of fan 112 via recess 134, and the rotation of fan 112 causes airflow (AF3) to move in a direction of rotation of fan 112 and/or radially outward toward tips 146 of each blade of the plurality of blades 142 of fan 112.

After circulation within second compartment 108 defined by shroud 106, airflow (AF4) is directed from second compartment 108 to exterior surface 40 and/or fins 42 of housing 12. In the exemplary embodiment, airflow (AF4) moves and/or is supplied along sidewalls 152 of shroud 106. Sidewalls 152 of shroud 106 direct airflow (AF4) in a direction toward exterior surface 40 and/or fins 42 of housing 12 for motor assembly 10. Additionally, and as discussed herein, the plurality of guide vanes 138 disposed over heatsink cover 110 and/or positioned between heatsink cover 110 and sidewalls 152 of shroud 106 further direct, supply, and/or facilitate the movement of airflow (AF4) toward housing 12. Airflow (AF4) reaching, contacting, and/or flowing over housing 12 cools housing 12, and in turn first compartment 16 and/or motor 18 disposed therein.

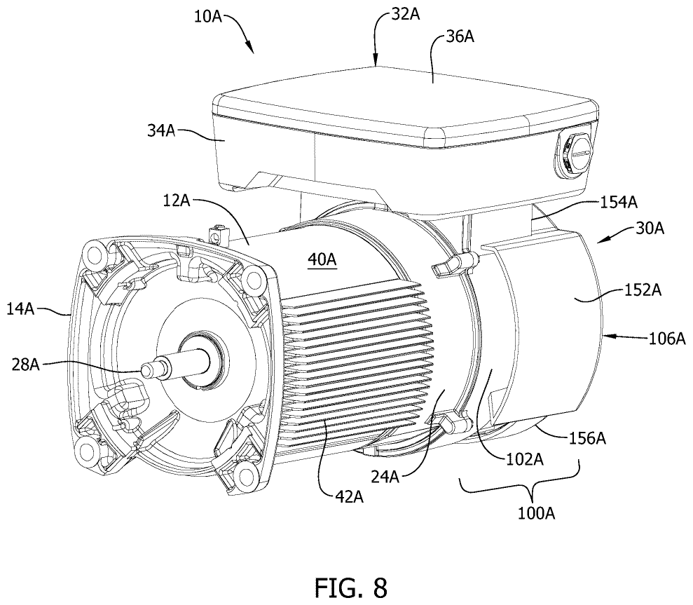

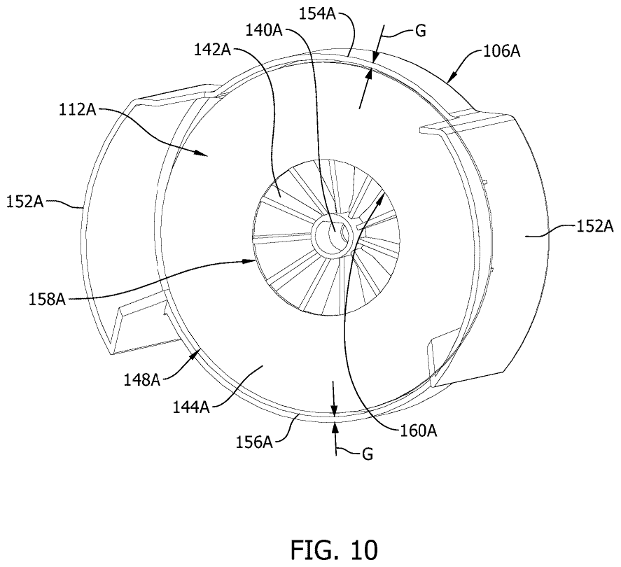

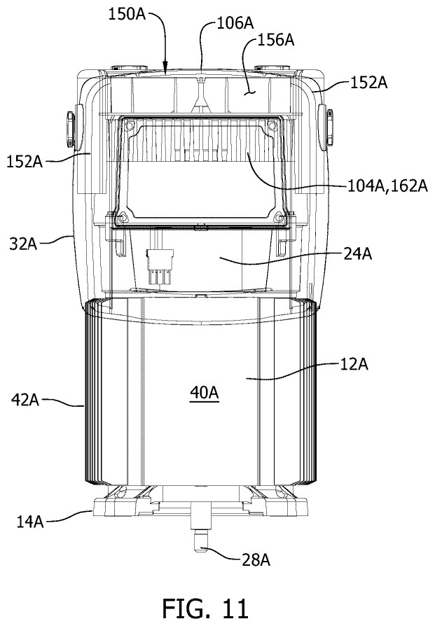

FIGS. 8-11 show another non-limiting example of motor assembly 10A including cooling system 100A. More specifically, FIG. 8 shows a perspective view of motor assembly 10A including cooling system 100A, FIG. 9 shows a partially exploded view of cooling system 100A for motor assembly 10A shown in FIG. 8, FIG. 10 shows a perspective view of shroud 106A and fan 112A of cooling system 100A, and FIG. 11 shows a bottom view of motor assembly 10A shown in FIG. 8. It is understood that similarly numbered and/or named components may function in a substantially similar fashion. Redundant explanation of these components has been omitted for clarity.

Motor assembly 10A shown in FIGS. 8-11 includes cooling system 100A having distinct configurations and/or features. For example, shroud 106A includes two opposing sidewalls 152A that extend toward housing 12A and only cover and/or surround a portion of heatsink casing 102A. Compared to sidewalls 152 of the shroud shown and discussed herein with respect to FIGS. 1-7, opposing sidewalls 152A of shroud 106A shown in FIGS. 8-11 only extend to cover and/or surround a portion of heatsink casing 102A, proximate to intermediary housing 24A.

As shown in FIGS. 8-10, two opposing sidewalls 152A of shroud 106A also include a curvature and/or a curved profile. In this embodiment, the curvature of opposing sidewalls 152A may correlate, correspond, and/or are substantially similar (e.g., concentric) with the curvature in sidewalls 128A of heatsink casing 102A, intermediary housing 24A, and/or exterior surface 40A of housing 12A for motor assembly 10A. As similarly discussed herein, the curvature of opposing sidewalls 152A and the channel formed between sidewalls 152A and the portion of heatsink casing 102A covered by opposing sidewalls 152A facilitates the flowing of the airflow from shroud 106A to housing 12A during operation.

Turning to FIG. 9, this embodiment excludes heatsink cover 110 (see e.g., FIGS. 4 and 5). Rather, fan 112A is disposed and/or positioned within second compartment 108A directly adjacent the plurality of heatsink protrusions 104A. However, and as shown, fan 112A is positioned within cooling system 100A in a different orientation compared to the embodiment shown in FIGS. 1-7. In the embodiment shown in FIGS. 8-10, fan shroud 144A is positioned directly adjacent the plurality of heatsink protrusions 104A, and/or between the plurality of heatsink protrusions 104A of heatsink casing 102A and the plurality of blades 142A. As such, the plurality of blades 142A are positioned directly adjacent end wall 150A of shroud 106A. In the exemplary embodiment, the plurality of blades 142A are positioned radially inward of outer perimeter 148A of fan shroud 144A. That is, tips 146A of each blade 142 are positioned, oriented, and/or disposed on fan shroud 144A, radially inward and/or adjacent to outer perimeter 148A.

Additionally as shown, fan shroud 144A includes an opening 158A through a center of fan shroud 144A, and concentrically aligned with shaft aperture 140A of fan 112A. Opening 158A is at least partially defined between shaft aperture 140A and an inner perimeter 160A of fan shroud 144A. Similar to recess 134 of heatsink cover 110 (see, FIG. 4), opening 158A centrally formed in fan shroud 144A allows airflow to flow to fan 112A during operation. More specifically, fan shroud 144A positioned directly adjacent and/or aligned with the plurality of heatsink protrusions 104A within heatsink casing 102A may ensure the plurality of heatsink protrusions 104A receive a desired amount of airflow and/or the airflow does not prematurely flow to fan 112A—similar to wall portion 132 of heatsink cover 110 discussed herein with respect to FIGS. 4 and 5. However, opening 158A enables the airflow previously flowed over the plurality of heatsink protrusions 104A to subsequently flow to fan 112A. In this embodiment, opening 158A is axially aligned with shaft 28A and the center of fan 112A to provide, supply, and/or flow airflow (AF) from the plurality of heatsink protrusions 104A, through opening 158A, and toward the center of fan 112A of cooling system 100A.

In addition to shortened, curved sidewalls 152A, shroud 106A also includes a substantially curved top wall 154A and a substantially curved bottom wall 156A, respectively. In this embodiment, the curvature of top wall 154A and bottom wall 156A may correspond to the curvature of fan 112A. As shown in FIG. 10, the curvature or curved profile of top wall 154A and bottom wall 156A correlates, corresponds, and/or is substantially similar (e.g., concentric) with the curvature the plurality of blades 142A and/or fan shroud 144A of fan 112A. As shown in FIG. 10, the curvatures of top wall 154A, bottom wall 156A, and fan shroud 144A may form a minimal clearance or gap (G) between curved top wall 154A/curved bottom wall 156A and fan shroud 144A. The minimal gap (G) between curved top wall 154A and/or curved bottom wall 156A and fan shroud 144A prevents undesirable recirculation or backflow of airflow (AF) from reentering heatsink casing 102.

Returning to FIG. 9, heatsink casing 102A also includes the plurality of guide vanes 138A (shown in phantom). As shown, the plurality of guide vanes 138A are positioned and/or formed directly on the curved sidewall 128A of heatsink casing 102A. In the non-limiting example, curved opposing sidewalls 152A of shroud 106A substantially cover and/or surround the plurality of guide vanes 138A during operation. As similarly discussed herein, the plurality of guide vanes 138A aid in guiding and/or flowing the airflow from shroud 106A to exterior surface 40A and/or fins 42A of housing 12A during operation.

Additionally, the plurality of heatsink protrusions 104A within heatsink casing 102A are formed as a plurality of pins 162A extending from surface 116A of heatsink casing 102A. As shown in FIG. 9, the plurality of parallel pins 162A extending substantially perpendicularly from surface 116A of heatsink casing 102A. Each of the plurality of parallel pins 162A forming the plurality of heatsink protrusions 104A are separated from adjacent fins 118A to allow airflow to flow through and/or between each of the plurality of parallel pins 162A to cool heatsink casing 102A.

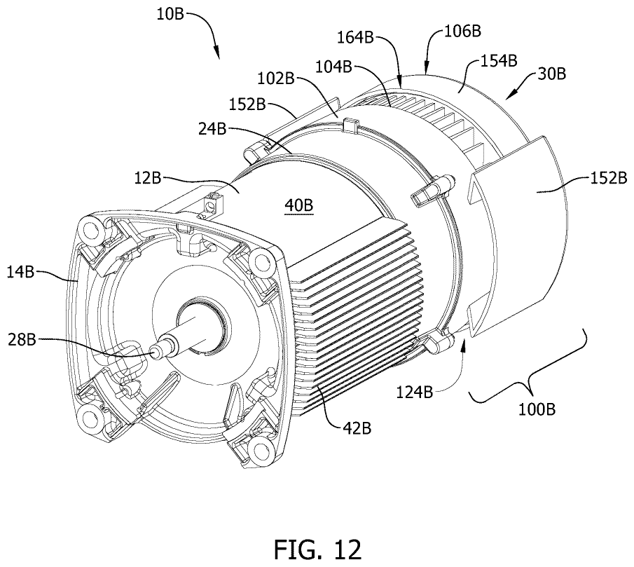

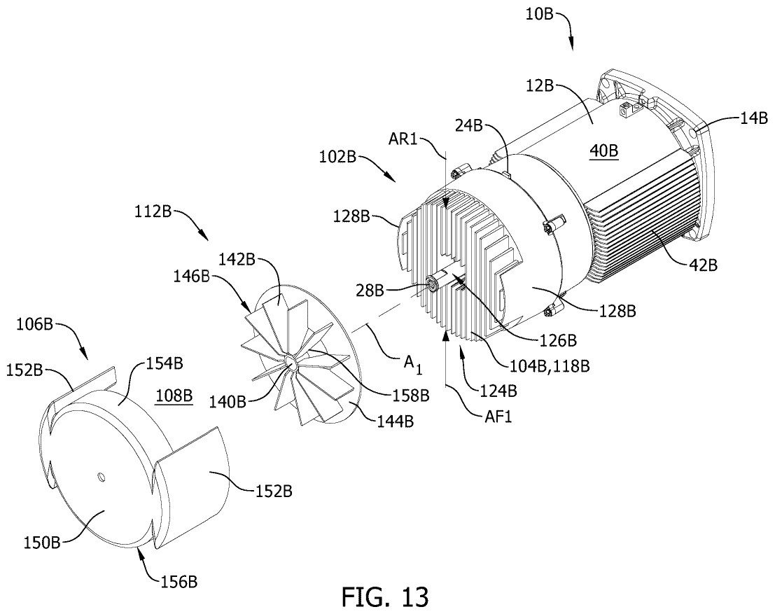

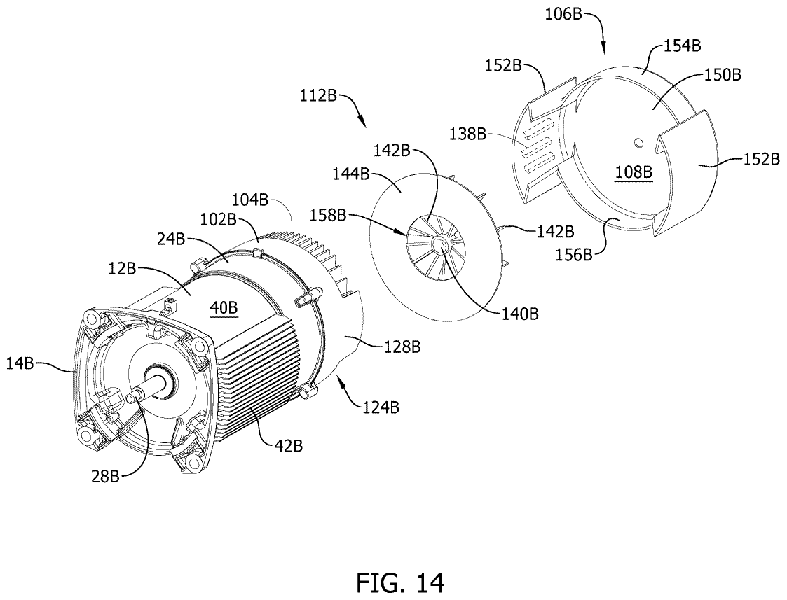

FIGS. 12-14 show a further embodiment of motor assembly 10B including cooling system 100B. More specifically, FIG. 12 shows a perspective view of motor assembly 10B including cooling system 100B, FIG. 13 shows a partially exploded rear perspective view of cooling system 100B for motor assembly 10B shown in FIG. 12, and FIG. 14 shows a partially exploded front perspective view of cooling system 100B for motor assembly 10B shown in FIG. 12.

In this embodiment, motor assembly 10B does not include terminal box 32B positioned above and coupled to heatsink casing 102B. As such, the plurality of heatsink protrusions 104B included within heatsink casing 102B are exposed above and below motor assembly 10B. More specifically, a top portion 164B and bottom portion 124B of heatsink casing 102B may expose a portion of the plurality of heatsink protrusions 104B. Including the plurality of heatsink protrusions 104B to be exposed in both top portion 164B and bottom portion 124B of heatsink casing 102B can increased the amount of airflow (AF1) that flows into heatsink protrusions 104B. Turning to FIG. 13, heatsink casing 102B also does not include passthrough section 122 (see, FIG. 5). In this embodiment, the plurality of heatsink protrusions 104B extending between top portion 164B and bottom portion 124B of heatsink casing 102B may also substantially surround shaft 28B extending into second compartment 108B defined by shroud 106B.

As shown in FIG. 14, the plurality of guide vanes 138B (shown in phantom) are positioned on an inner surface of opposing sidewalls 152B of shroud 106B. In this embodiment, the plurality of guide vanes 138B are disposed between the curved opposing sidewalls 152B of shroud 106B and curved sidewalls 128B of heatsink casing 102B during operation. As similarly discussed herein, the plurality of guide vanes 138B aid in guiding and/or flowing the airflow from shroud 106B to exterior surface 40B and/or fins 42B of housing 12B during operation.

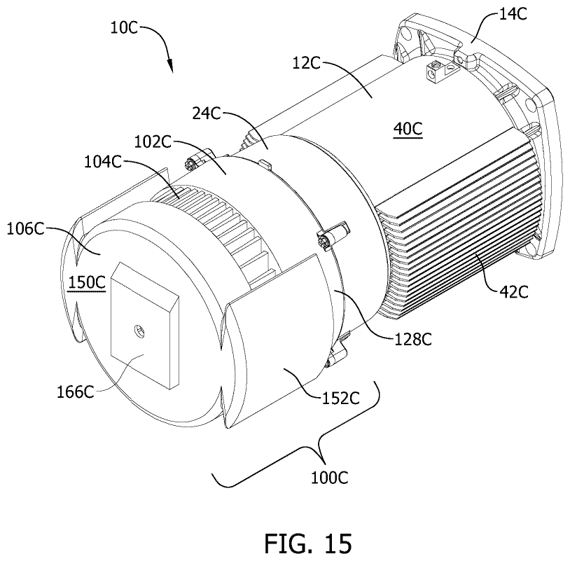

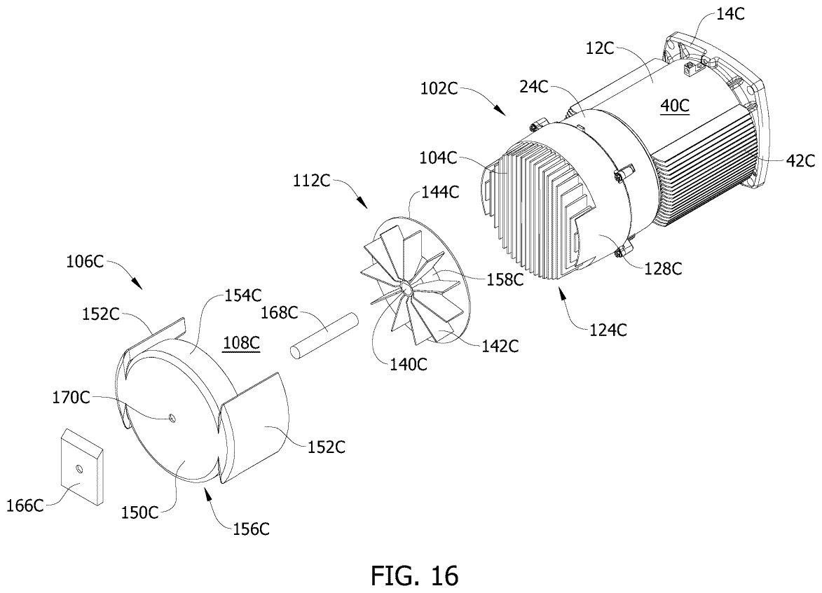

FIGS. 15 and 16 show another embodiment of motor assembly 10C including cooling system 100C. FIG. 15 shows a perspective view of motor assembly 10C and FIG. 16 shows a partially exploded, perspective view of motor assembly 10C. It is understood that similarly numbered and/or named components may function in a substantially similar fashion. Redundant explanation of these components has been omitted for clarity.

As shown in FIGS. 15 and 16 motor assembly 10C includes a motor 18C including shaft 28C, as well as a distinct, fan motor 166C and a distinct, fan shaft 168C coupled to fan motor 166C. As described herein, fan motor 166C and fan shaft 168C may drive and/or rotate fan 112C of cooling system 100C, independent of motor 18C and shaft 28C. As shown, fan motor 166C is coupled to and/or positioned adjacent end wall 150C of shroud 106C for cooling system 100C. Fan motor 166C can include any suitable motor structure or assembly that is configured to rotate fan shaft 168C, and in turn, fan 112C coupled to fan shaft 168C. For example, fan motor 166C can include a rotor and a stator circumscribing the rotor.

Additionally, fan 112C is coupled to a portion or end of fan shaft 168C positioned or extending within second compartment 108C. Fan shaft 168C extends into second compartment 108C defined by shroud 106C and also extends through and/or is received by a hole 170C formed in end wall 150C of shroud 106C to be coupled to fan motor 166C. As such, fan 112C is also positioned within second compartment 108C at least partially defined by shroud 106C, and is positioned adjacent and/or between shroud 106C and heatsink casing 102C including the plurality of heatsink protrusions 104C. In this embodiment, and as a result of shaft 28C not extending into second compartment 108C and/or fan 112C being coupled to the distinct, fan shaft 168C, the plurality of heatsink protrusions 104C extend over the entire surface of heatsink casing 102C. Additionally, heatsink casing 102C does not include opening 126C formed therethrough.

As similarly described herein, fan 112C of cooling system 100C is configured to draw airflow from the plurality of heatsink protrusions 104C and subsequently flow the airflow toward housing 12C of motor assembly 10C. However, distinct from the non-limiting examples described herein with respect to FIGS. 1-14, motor assembly 10C including fan motor 166C and fan shaft 168C may operate and/or rotate fan 112C at a speed independent of the rotational speed of shaft 28C for motor 18C. As such, motor assembly 10C shown in FIGS. 15 and 16 can rotate fan 112C at an increased rotational speed, and ultimately generate additional and/or improved cooling for housing 12C when motor 18C is not in operation and/or operating at a reduced speed (e.g., lower rotational speed of shaft 28C).

One of the many benefits of the described motor assembly 10C including cooling system 100C is the plurality of heatsink protrusions 104C of heatsink casing 102C and fan 112C are configured to collectively direct the airflow into fan 112C. Specifically, fan shroud 144C of fan 112C is positioned adjacent spaces 120C defined by the plurality of heatsink protrusions 104C of heatsink casing 102C within second compartment 108C defined, at least in part, by shroud 106C. The airflow travels from outside heatsink casing 102C, through the plurality of protrusions 104C and is subsequently introduced into fan 112C through recess 134C and/or opening 158C formed through fan shroud 144C. Fan 112C circulates the airflow and, with the assistance of shroud 106C, directs the airflow along exterior surface 40C and/or fins 42C of housing 12C and/or into first compartment 16C of motor assembly 10C.

This written description uses examples to disclose the embodiment, including the best mode, and also to enable any person skilled in the art to practice the invention, including making and using any devices or systems and performing any incorporated methods. The patentable scope of the embodiment is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A motor assembly comprising:
a housing;
a mounting bracket coupled to an end of said housing, said mounting bracket and said housing defining a first compartment;
a motor positioned within said first compartment;
a heatsink casing coupled to said housing, opposite said mounting bracket, said heatsink casing including a plurality of heatsink protrusions disposed within said heatsink casing and configured to receive airflow surrounding said housing;
a shroud positioned adjacent said heatsink casing, opposite said mounting bracket, said shroud defining a second compartment;
a shaft coupled to said motor and configured to rotate about an axis, said shaft extends axially through said heatsink casing and said second compartment defined by said shroud; and
a fan coupled to said shaft and positioned within said second compartment, between said shroud and said plurality of heatsink protrusions disposed within said heatsink casing, said fan configured to draw airflow from said plurality of heatsink protrusions.

2. The motor assembly of claim 1, wherein said fan includes:
a shaft aperture configured to receive said shaft;
a plurality of blades radially positioned around the axis; and
a fan shroud coupled to each of said plurality of blades, said fan shroud concentrically aligned with said shaft aperture.

3. The motor assembly of claim 2, wherein said fan shroud includes an opening concentrically aligned with said shaft aperture and enabling fluid communication between said plurality of heatsink protrusions and said second compartment of said shroud.

4. The motor assembly of claim 2, wherein said fan shroud of said fan is one of, positioned directly between said plurality of heatsink protrusions and said plurality of blades, or positioned between said plurality of blades and said shroud.

5. The motor assembly of claim 2, wherein said plurality of blades one of extend radially beyond an outer perimeter of said fan shroud, or positioned inward of the outer perimeter of said fan shroud.

6. The motor assembly of claim 1, wherein said plurality of heatsink protrusions is formed as at least one of:
a plurality of radial fins,
a plurality of parallel fins, and
a plurality of pins.

7. The motor assembly of claim 1, further comprising a heatsink cover coupled to said heatsink casing, said heatsink cover including:
opposing sidewalls positioned directly adjacent said heatsink casing;
a wall portion extending between said opposing sidewalls, said wall portion positioned between said plurality of heatsink protrusions and said fan;
a recess formed in said wall portion for enabling fluid communication between said plurality of heatsink protrusions and said fan; and
an inlet defined by said opposing sidewalls and said wall portion, said inlet formed directly adjacent and exposing at least a portion of said plurality of heatsink protrusions.

8. The motor assembly of claim 7, further comprising a plurality of guide vanes formed on at least one of:
said opposing sidewalls of said heatsink cover,
an outer surface of said heatsink casing, and
an inner surface of said shroud, adjacent said heatsink cover or said heatsink casing.

9. The motor assembly of claim 1, wherein said shroud further includes:
an end wall positioned adjacent said fan;
two opposing sidewalls extending from said end wall toward said housing, said two opposing sidewalls extending adjacent and at least partially surrounding at least one of said heatsink casing and said housing;
a top wall extending from said end wall toward said heatsink casing and disposed over said fan; and
a bottom wall extending from said end wall toward said heatsink casing and disposed below said fan, wherein said plurality of heatsink protrusions are exposed adjacent at least one of said top wall and said bottom wall.

10. The motor assembly of claim 9, wherein said top wall of said shroud contacts said heatsink casing.

11. The motor assembly of claim 9, wherein said top wall and said bottom wall of said shroud are substantially curved to concentrically correlate to said fan.

12. The motor assembly of claim 9, wherein said two opposing sidewalls of the shroud are substantially curved and concentrically correlate to at least one of said heatsink casing and said housing.

13. A motor assembly comprising:
a housing defining a first compartment;
a mounting bracket coupled to an end of said housing;
a motor positioned within the first compartment;
a heatsink casing coupled to said housing, opposite said mounting bracket, said heatsink casing including a plurality of heatsink protrusions disposed within said heatsink casing and configured to receive airflow surrounding said housing;
a shroud positioned adjacent said heatsink casing, opposite said mounting bracket, said shroud defining a second compartment; and
a fan positioned within the second compartment, between said shroud and said plurality of heatsink protrusions disposed within said heatsink casing, said fan configured to draw airflow from said plurality of heatsink protrusions.

14. The motor assembly of claim 13, further comprising a shaft coupled to said motor and configured to rotate about an axis, said shaft extending axially through said heatsink casing and the second compartment defined by said shroud, wherein said fan is coupled to said shaft.

15. The motor assembly of claim 13, further comprising:
a motor shaft coupled to said motor and configured to rotate about an axis; and
a fan shaft coupled to said fan and configured to rotate, said fan shaft extending through the second compartment defined by said shroud and received by a hole formed in said shroud.

16. The motor assembly of claim 13, wherein said fan includes:
a plurality of blades radially positioned around the axis; and
a fan shroud coupled to each of said plurality of blades, said fan shroud concentrically aligned with the shaft aperture.

17. The motor assembly of claim 13, further comprising a heatsink cover coupled to said heatsink casing, said heatsink cover including:
opposing sidewalls positioned directly adjacent said heatsink casing;
a wall portion extending between said opposing sidewalls, said wall portion positioned between said plurality of heatsink protrusions and said fan;
a recess formed in said wall portion for enabling fluid communication between said plurality of heatsink protrusions and said fan; and
an inlet defined by said opposing sidewalls and said wall portion, said inlet formed directly adjacent and exposing at least a portion of said plurality of heatsink protrusions.

18. The motor assembly of claim 13, wherein said shroud further includes:
an end wall;
two opposing sidewalls extending from said end wall toward said housing, said two opposing sidewalls extending adjacent and at least partially surrounding at least one of said heatsink casing and said housing;
a top wall extending from said end wall toward said heatsink casing and disposed over said fan; and
a bottom wall extending from said end wall toward said heatsink casing and disposed below said fan, wherein said plurality of heatsink protrusions are exposed adjacent at least one of said top wall and said bottom wall.

19. A method of operating a motor assembly, wherein the motor assembly includes a housing defining a first compartment; a mounting bracket coupled to an end of the housing; a motor positioned within the first compartment; a heatsink casing coupled to the housing, opposite the mounting bracket, the heatsink casing including a plurality of heatsink protrusions disposed within the heatsink casing; a shroud positioned adjacent the heatsink casing, opposite the mounting bracket, the shroud defining a second compartment; a shaft coupled to the motor and extending axially through the heatsink casing and the second compartment defined by the shroud; and a fan coupled to the shaft and positioned within the second compartment, between the shroud and the plurality of heatsink protrusions disposed within the heatsink casing, said method comprising:
drawing airflow from outside the motor assembly through the plurality of heatsink protrusions included within the heatsink casing;
flowing the airflow from the plurality of heatsink protrusions to the fan positioned within the second compartment defined by the shroud;
circulating the airflow within the second compartment of the shroud based on a rotation of the fan; and
directing the airflow from the second compartment of the shroud to an exterior of the housing.

20. The method of claim 19, wherein said flowing of the airflow from the plurality of heatsink protrusions to the fan positioned within the second compartment defined by the shroud further includes inducing the airflow through an opening formed through a fan shroud of the fan to contact a plurality of blades of the fan, the fan shroud coupled to each of the plurality of blades of the fan.
